(19) United States
(12) Patent Application Publication
(10) Pub. No.: US 2026/0200138 A1
(43) Pub. Date: Jul. 16, 2026

(54) COMPOSITION FOR MANUFACTURING ECO-FRIENDLY MAT, MANUFACTURING METHOD OF ECO-FRIENDLY MAT, AND ECO-FRIENDLY MAT

(71) Applicant: DAH SHENG CHEMICAL INDUSTRY CO., LTD., TAICHUNG CITY (TW)

(72) Inventors: Heng-Tai CHANG, TAICHUNG CITY (TW); Hsun-Chen CHANG, TAICHUNG CITY (TW)

(21) Appl. No.: 19/221,855

(22) Filed: May 29, 2025

(30) Foreign Application Priority Data
Jan. 15, 2025 (TW) 114101653

(51) Int. Cl. B29B 17/04; B29K 23/00; B29K 75/00; B29K 105/12; B29K 105/26; B29K 471/00; B29L 7/00

(52) U.S. Cl. CPC B29B 17/04; B29B 2017/042; B29K 2023/083; B29K 2075/00; B29K 2105/12; B29K 2105/26; B29K 2471/00; B29K 2995/007; B29K 2995/0081; B29L 2007/002

(57) ABSTRACT

A composition for manufacturing an eco-friendly mat includes recycled polymer scraps, recycled fiber scraps, and a polyether-based adhesive. The recycled polymer scraps have an average particle size between 0.3 mm to 5 mm and the recycled fiber scraps have an average fiber length between 0.3 mm to 5 mm. The recycled polymer scraps are TPU and/or EVA copolymer and are derived from recycled insole pads, waste generated during the manufacturing of TPU and/or EVA copolymer, and offcuts generated in the process of making insole pads. The recycled fiber scraps include plant fibers, animal fibers, and/or synthetic fibers and are derived from the fabrics attached to the recycled insole pads. Based on 100 parts by weight of the polyether-based adhesive, the composition contains 260 to 340 parts by weight of the recycled polymer scraps and 10 to 100 parts by weight of the recycled fiber scraps.

### FIELD OF THE INVENTION

The present disclosure relates to the recycling and processing of plastics and, more particularly, to a composition for manufacturing an eco-friendly mat, a manufacturing method of eco-friendly mat, and an eco-friendly mat produced from the composition.

### BACKGROUND OF THE INVENTION

Most commercially available insoles consist primarily of a pad made of thermoplastic polyurethane (TPU) or ethylene vinyl acetate (EVA) copolymer. Since insoles need to be in contact with the soles of the feet for a long period of time, they are often covered with a fabric layer, such as breathable fiber cloth, to enhance breathability.

Due to growing environmental awareness, many manufacturers are attempting to recycle insoles and reprocess these recycle insoles into new insole pads. However, in order to prevent the recycled materials from being difficult to reprocess into a new pad, or to prevent the resulting pad from having the physical properties unsuitable for reuse in insoles, the existing processing methods must first separate the fabric layer from the pad one by one to ensure that the recycled materials do not contain fabric scraps, making the entire recycling and manufacturing process complex and time-consuming.

### SUMMARY OF THE INVENTION

The present disclosure has been accomplished in view of the above-noted circumstances. It is an objective of the present disclosure to provide a composition for manufacturing an eco-friendly mat, which can still be used to produce an eco-friendly mat with physical properties suitable for use as an insole pad despite containing both recycled polymer scraps and recycled fiber scraps.

Another objective of the present disclosure is to provide a manufacturing method of an eco-friendly mat, which is more simplified and time-efficient in comparison with conventional recycling and manufacturing methods.

Yet another objective of the present disclosure is to provide an eco-friendly mat produced from the composition of the present disclosure, which possesses physical properties suitable for use as an insole pad.

To attain the above objectives, one aspect of the present disclosure provides a composition for manufacturing an eco-friendly mat, comprising recycled polymer scraps, recycled fiber scraps, and a polyether-based adhesive. The recycled polymer scraps have an average particle size ranging from 0.3 mm to 5 mm and are thermoplastic polyurethane (TPU) and/or ethylene-vinyl acetate (EVA) copolymer. Furthermore, the recycled polymer scraps are derived from recycled insole pads or from recycled insole pads and at least one of the following: waste generated during the manufacturing of TPU and/or EVA copolymer, and offcuts generated in the process of making insole pads. The recycled fiber scraps have an average fiber length ranging from 0.3 mm to 5 mm and include plant fibers, animal fibers, synthetic fibers, or a mixture of at least two of the aforesaid fibers. In addition, the recycled fiber scraps are derived from fabrics attached to the recycled insole pads. Based on 100 parts by weight of the polyether-based adhesive, the composition comprises 260 to 340 parts by weight of the recycled polymer scraps and 10 to 100 parts by weight of the recycled fiber scraps.

According to one embodiment of the present disclosure, the recycled polymer scraps have an average particle size ranging from 0.5 mm to 1.5 mm and the recycled fiber scraps have an average fiber length ranging from 0.5 mm to 1.5 mm.

To attain the above objectives, another aspect of the present disclosure provides a manufacturing method of eco-friendly mat, comprising a recycling step, a shredding step, a heating and mixing step, and a cooling and molding step.

The recycling step includes the collection of recycled insoles or the collection of recycled insoles and at least one of waste generated during the production of TPU and/or EVA copolymer and offcuts generated during the production of insole pads, so as to obtain recycled materials. The recycled insoles comprise pads and fabrics attached to the pads. The pads are made of TPU and/or EVA copolymer, and the fabrics are made from plant fibers, animal fibers, synthetic fibers, or a mixture of at least two of the aforesaid fibers.

In the shredding step, the recycled materials are shredded to obtain recycled polymer scraps with an average particle size between 0.3 mm to 5 mm and recycled fiber scraps with an average fiber length between 0.3 mm to 5 mm.

In the heating and mixing step, based on 100 parts by weight of the polyether-based adhesive, 260 to 340 parts by weight of the recycled polymer scraps and 10 to 100 parts by weight of the recycled fiber scraps are heated and homogeneously mixed with the polyether-based adhesive to obtain a composition.

In the cooling and molding step, the composition obtained from the heating and mixing step is introduced into a mold, cooled to solidify, and then demolded to produce the eco-friendly mat.

According to one embodiment of the present disclosure, the shredding step is carried out using a shredder to shred the recycled materials.

According to one embodiment of the present disclosure, the heating and mixing step is carried out using steam heating within a temperature range of 100° C. to 140° C.

According to one embodiment of the present disclosure, the cooling and molding step is performed by placing the mold containing the composition in an oven at a temperature of 50° C. to 60° C. for 5 to 8 hours to cool and solidify the composition.

To attain the above objectives, another aspect of the present disclosure provides an eco-friendly mat produced from the composition of the present disclosure.

According to one embodiment of the present disclosure, the eco-friendly mat exhibits the following properties: a tear strength of 0.6 kg/cm or higher, measured according to ASTM D624; an impact resilience of 24% to 28%, measured according to ASTM D2632; a specific gravity of 0.19 to 0.27 g/cm³, measured according to NIKE Test G43; and an ASKER C hardness of 26 to 48, measured according to NIKE Test G45.

The present disclosure provides a composition for manufacturing an eco-friendly mat, an eco-friendly mat produced from the composition, and a method for manufacturing the eco-friendly mat. Based on the present disclosure, the resulting eco-friendly mat, despite containing recycled fiber scraps, still possesses physical properties suitable for use as an insole pad. Additionally, the manufacturing method of the present disclosure provides a simplified and time-efficient process.

### BRIEF DESCRIPTION OF DRAWINGS

FIG. 1 illustrates a flowchart of the manufacturing method of the present disclosure.

FIG. 2 is a schematic view showing a specimen according to NIKE Test G45.

### DETAILED DESCRIPTION OF THE INVENTION

The present disclosure will be described in further detail by reference to specific embodiments. However, the described embodiments and/or examples are merely a portion of the embodiments and/or examples of the present disclosure and do not encompass all embodiments and/or examples. Various modifications and variations that a person skilled in the art may make based on the embodiments and/or examples disclosed in the present disclosure, without departing from the spirit of the present disclosure, shall fall within the scope of the present disclosure.

The present disclosure provides a composition for manufacturing an eco-friendly mat, comprising recycled polymer scraps, recycled fiber scraps, and a polyether-based adhesive.

### Recycled Polymer Scraps

The recycled polymer scraps may be TPU, EVA copolymer, or a mixture thereof. Preferably, the average particle size of the recycled polymer scraps is between 0.3 mm and 5 mm, and more preferably between 0.5 mm and 1.5 mm. If the average particle size of the recycled polymer scraps is less than 0.3 mm, the adhesion between the scraps is reduced, thereby affecting the molding of the eco-friendly mat. If the average particle size of the recycled polymer scraps exceeds 5 mm, it would be difficult to control the hardness of the eco-friendly mat thus obtained.

The recycled polymer scraps may be derived solely from recycled insole pads, or from recycled insole pads in combination with at least one of the following: waste generated during the manufacturing of TPU and/or EVA copolymer, and offcuts generated in the process of making insole pads.

### Recycled Fiber Scraps

The recycled fiber scraps may include plant fibers, animal fibers, synthetic fibers, or a mixture of at least two of the aforesaid fibers. Preferably, the average fiber length of the recycled fiber scraps is between 0.3 mm and 5 mm, and more preferably between 0.5 mm and 1.5 mm. If the average fiber length of the recycled fiber scraps is less than 0.3 mm, the adhesion between the scraps is reduced, thereby affecting the molding of the eco-friendly mat. If the average fiber length of the recycled fiber scraps exceeds 5 mm, it would be difficult to control the hardness of the eco-friendly mat thus obtained.

The recycled fiber scraps may be obtained from the fabrics attached to the recycled insole pads. In practical applications, the recycled insoles may be directly shredded without separating the fabric layers from the pads, so as to simultaneously obtain both the recycled polymer scraps and the recycled fiber scraps.

The polyether-based adhesive used in the present disclosure is not particularly limited, and one that can homogeneously mix and firmly bond the recycled polymer scraps and the recycled fiber scraps may be adopted in the present disclosure.

In the composition for manufacturing an eco-friendly mat of the present disclosure, based on 100 parts by weight of the polyether-based adhesive, the content of the recycled polymer scraps is preferably about 260 to 340 parts by weight, and the content of the recycled fiber scraps is preferably about 10 to 100 parts by weight, more preferably about 40 to 100 parts by weight. If the content of the recycled polymer scraps is lower than 260 parts by weight, the physical properties of the resulting eco-friendly mat may deteriorate; if the content of the recycled polymer scraps exceeds 340 parts by weight, the physical properties of the resulting eco-friendly mat may also deteriorate, and particularly resulting in excessive hardness. In addition, if the content of the recycled fiber scraps is lower than 10 parts by weight, the content of the recycled polymer scraps may be too high, making the resulting mat less environmentally friendly. If the content of the recycled fiber scraps exceeds 100 parts by weight, the physical properties of the resulting eco-friendly mat may deteriorate.

In another aspect, the present disclosure further provides an eco-friendly mat, which is produced from the above-mentioned composition. Although the eco-friendly mat contains recycled fiber scraps, it still possesses physical properties suitable for use as an insole pad. Preferably, the eco-friendly mat of the present disclosure has the physical properties of a tear strength of 0.6 kg/cm or higher as measured by ASTM D624, an impact resilience of 24% to 28% as measured by ASTM D2632, a specific gravity of 0.19 to 0.27 g/cm³ as measured by NIKE Test G43, and an ASKER C hardness of 26 to 48 as measured by NIKE Test G45.

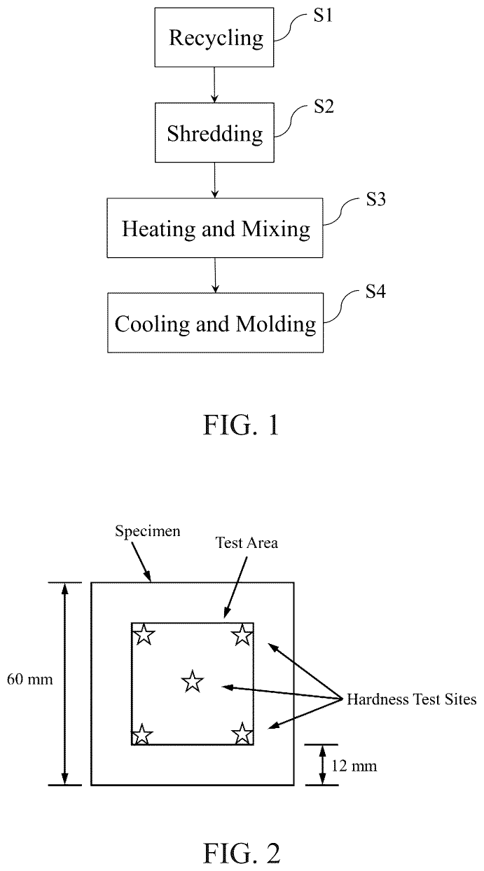

In a further aspect, the present disclosure provides a method for manufacturing an eco-friendly mat. Referring to FIG. 1, the manufacturing method of the present disclosure comprises the steps set forth below.

### Recycling Step (S1)

Collecting recycled materials, wherein the recycled materials are recycled insoles or include recycled insoles along with at least one of the following: waste generated during the production of TPU and/or EVA copolymer, and offcuts generated during the production of insole pads. The recycled insoles comprise pads and fabrics attached to the pads. The pads may be made of TPU, EVA copolymer, or a mixture thereof. The fabrics may be made from plant fibers, animal fibers, synthetic fibers, or a mixture of at least two thereof.

### Shredding Step (S2)

Shredding the recycled materials obtained in the recycling step (S1) to obtain recycled polymer scraps having an average particle size of 0.3 mm to 5 mm and recycled fiber scraps having an average fiber length of 0.3 mm to 5 mm.

In the present disclosure, the shredding step (S2) may be performed by using a shredder to obtain the recycled materials.

### Heating and Mixing Step (S3)

Heating and homogeneously mixing the recycled polymer scraps, the recycled fiber scraps, and a polyether-based adhesive to obtain a composition, wherein, based on 100 parts by weight of the polyether-based adhesive, the recycled polymer scraps are present in an amount of 260 to 340 parts by weight, and the recycled fiber scraps are present in an amount of 10 to 100 parts by weight.

In the present disclosure, the heating and mixing step (S3) may be performed by steam heating the composition at a temperature ranging from 100° C. to 140° C. If the temperature is lower than 100° C., water vapor cannot be generated to react with the adhesive. If the temperature is higher than 140° C., the properties of the adhesive may be deteriorated, thereby affecting the physical properties of the resulting eco-friendly mat.

### Cooling and Molding Step (S4)

Introducing the composition obtained in the heating and mixing step (S3) into a mold, cooling and molding the composition, and then demolding to obtain the eco-friendly mat.

In the present disclosure, the cooling and molding step (S4) may be performed by placing the mold containing the composition in an oven at a temperature of 50° C. to 60° C. for 5 to 8 hours to cool and solidify the composition. If the temperature is lower than 50° C., the drying and solidifying efficiency may be poor due to the low temperature. If the temperature is higher than 60° C., the physical properties of the resulting eco-friendly mat may be undesirably affected. Additionally, if the cooling time is less than 5 hours, the composition may not be completely cooled and solidified to obtain a mat, whereas a cooling time of 8 hours is sufficient to cool and solidify the composition.

According to the present disclosure, a composition for manufacturing an eco-friendly mat, an eco-friendly mat manufactured from the composition, and a method for manufacturing the eco-friendly mat are provided. Despite the fact that the eco-friendly mat obtained from the composition contains recycled fiber scraps, it still exhibits physical properties suitable for use as an insole pad. Furthermore, the manufacturing method of the present disclosure simplifies the process and improves time efficiency.

The technical content of the present disclosure is further described through the following specific examples. However, these examples are provided for illustrative purposes only and should not be construed as limiting the present disclosure.

### Example 1

The recycled insoles are used as the recycled materials and are shredded by a shredder to obtain recycled polymer scraps having an average particle size of 3 mm and recycled fiber scraps having an average fiber length of 3 mm. Using steam heating to heat and mix 170 parts by weight of the recycled polymer scraps, 50 parts by weight of the recycled fiber scraps, and 50 parts by weight of the polyether-based adhesive at a temperature of about 120° C. to obtain a composition. The composition thus obtained is introduced into a mold and cooled in an oven at a temperature of 50° C. to 60° C. for 6 hours to produce the eco-friendly mat of Example 1.

The eco-friendly mat obtained in Example 1 is evaluated for its physical properties, including tear strength, impact resilience, specific gravity, and ASKER C hardness, according to ASTM D624, ASTM D2632, NIKE Test G43, and NIKE Test G45, respectively. The evaluation results are shown in Table 1 below.

### Example 2

The eco-friendly mat of Example 2 is manufactured in substantially the same manner as in Example 1, except that the recycled materials included both recycled insoles and waste generated during the production of TPU and/or EVA copolymer. In addition, the amount of the recycled polymer scraps is 150 parts by weight, and the amount of the recycled fiber scraps is 35 parts by weight.

The eco-friendly mat obtained in Example 2 is also evaluated for tear strength, impact resilience, specific gravity, and ASKER C hardness properties, and the evaluation results are shown in Table 1.

### Example 3

The eco-friendly mat of Example 3 is manufactured in substantially the same manner as in Example 1, except that the recycled materials include recycled insoles, waste generated during the production of TPU and/or EVA copolymer, and offcuts generated during the production of insole pads. In addition, the amount of the recycled polymer scraps is 130 parts by weight, and the amount of the recycled fiber scraps is 20 parts by weight.

The eco-friendly mat obtained in Example 3 is also evaluated tear strength, impact resilience, specific gravity, and ASKER C hardness properties, and the evaluation results are shown in Table 1.

### Comparative Example 1

The eco-friendly mat of Comparative Example 1 is manufactured in substantially the same manner as in Example 1, except that the average particle size of the recycled polymer scraps is not within the range of 0.3 mm to 5 mm, and the average fiber length of the recycled fiber scraps is not within the range of 0.3 mm to 5 mm.

The result indicates that Comparative Example 1 cannot successfully form a mat.

### Comparative Example 2

The eco-friendly mat of Comparative Example 2 is manufactured in substantially the same manner as in Example 2, except that the amount of the recycled polymer scraps is 75 parts by weight, the amount of the recycled fiber scraps is 75 parts by weight, and the amount of the polyether-based adhesive is 35 parts by weight.

The results indicates that Comparative Example 2 cannot successfully form a mat.

### Evaluation of Physical Properties

### ASTM D624 Test (Tear Strength Test)

In accordance with ASTM D624, a tensile testing machine is used to measure the eco-friendly mats of Examples 1 to 3. The eco-friendly mats obtained in Examples 1 to 3 are cut into specimens measuring 50.8 mm×50.8 mm, and the thickness of the specimens is measured. The speed of the tensile testing machine is set to 500 mm/min. Each specimen is clamped between the upper and lower grips to measure the maximum tensile force at which the specimen breaks. Tear strength is calculated using the following Equation 1.

$$Tear Strength = \frac{Maximum Tensile Force}{Thickness} \qquad [ Equation 1 ]$$

### ASTM D2632 Test (Impact Resilience Test)

In accordance with ASTM D2632, a universal testing machine is used to measure the eco-friendly mats of Examples 1 to 3. The eco-friendly mats obtained in Examples 1 to 3, with a thickness of 12.5±0.5 mm, are cut into specimens measuring 50.8 mm×50.8 mm. Each specimen is placed at the center of the test platform. The piston rod is adjusted to lightly press the specimen for fixation, and the lever is actuated to release the piston, allowing the piston to rebound. Each specimen is measured six times, and the average of the last three measurements is taken and recorded in Table 1.

### NIKE Test G43 (Specific Gravity)

In accordance with NIKE Test G43, each of the eco-friendly mats obtained in Examples 1 to 3 is cut into three specimens measuring 50.8 mm×50.8 mm. The mass (m) of each specimen is measured using an electronic balance with accuracy 0.001 g, and the thickness (a) of each specimen is measured using a vernier caliper. The specific gravity (p) is calculated using the following Equation (2), and the average of the three specimens of each Example is recorded in Table 1.

$$ρ = \frac{m}{a \times 5.08 \times 5.08} \qquad [ Equation 2 ]$$

### NIKE Test G45

In accordance with NIKE Test G45, the eco-friendly mats obtained in Examples 1 to 3 are cut into specimens, each with a thickness of 6 mm. The hardness at the hardness test sites within the test area shown in FIG. 2 is measured under a temperature of 22±2° C. and a relative humidity of 50%+5%. The results are recorded in Table 1.

TABLE 1

| | Tear | Impact | Specific | |
|---|---|---|---|---|
| | Strength | Resilience | Gravity | ASKER C |
| | (kg/cm) | (%) | (g/cm³) | hardness |
| Example 1 | 1.59-2.09 | 26-28 | 0.2536~0.2709 | 39-48 |
| Example 2 | 1.49-1.83 | 26-28 | 0.2216~0.2400 | 35-41 |
| Example 3 | 0.65-1.01 | 24-26 | 0.1959~0.2106 | 26-38 |

| | |
|---|---|
| Compar. Example 1 | Failed to be molded into a mat |
| Compar. Example 2 | Failed to be molded into a mat |

From the results shown in Table 1, in comparison with Comparative Examples 1 and 2, which completely failed to be molded into a mat, the eco-friendly mats of Examples 1 to 3 produced using the composition of the present disclosure still has a tear strength of 0.6 kg/cm or higher, an impact resilience of 24% to 28%, a specific gravity of 0.19 to 0.27 g/cm³, and an ASKER C hardness of 26 to 48, even though the eco-friendly mats of Examples 1 to 3 contain recycled fiber scraps. Accordingly, it is apparent that the composition of the present disclosure is capable of producing eco-friendly mats with physical properties suitable for use as insole pads.

Consequently, because the composition and manufacturing method provided by the present disclosure can effectively reuse the recycled insoles, waste materials, or offcuts to produce the mats suitable for use as insole pads, the present disclosure is highly environmentally friendly. Moreover, compared to conventional methods of manufacturing mats from recycled insoles, the manufacturing method of the present disclosure eliminates the process of separating fabric layers from pads. As a result, the manufacturing method of the present disclosure is advantageous in simplified process, reduced manufacturing time, and improved production efficiency.

1. A composition for manufacturing an eco-friendly mat, comprising:
recycled polymer scraps having an average particle size ranging from 0.3 mm to 5 mm, wherein the recycled polymer scraps are TPU and/or EVA copolymer, and the recycled polymer scraps are derived from recycled insole pads or from recycled insole pads and at least one of the following: waste generated during the manufacturing of TPU and/or EVA copolymer, and offcuts generated during the production of insole pads;
recycled fiber scraps having an average fiber length ranging from 0.3 mm to 5 mm, wherein the recycled fiber scraps are at least one selected from the group consisting of plant fibers, animal fibers, and synthetic fibers, and the recycled fiber scraps are derived from fabrics attached to the recycled insole pads; and
a polyether-based adhesive;
wherein, based on 100 parts by weight of the polyether-based adhesive, the composition comprises 260 to 340 parts by weight of the recycled polymer scraps and 10 to 100 parts by weight of the recycled fiber scraps.

2. The composition for manufacturing an eco-friendly mat as claimed in claim 1, wherein the recycled polymer scraps have an average particle size from 0.5 mm to 1.5 mm.

3. The composition for manufacturing an eco-friendly mat as claimed in claim 1, wherein the recycled fiber scraps have an average fiber length from 0.5 mm to 1.5 mm.

4. The composition for manufacturing an eco-friendly mat as claimed in claim 1, wherein based on 100 parts by weight of the polyether-based adhesive, the recycled fiber scraps are in an amount of 40 to 100 parts by weight.

5. A manufacturing method of eco-friendly mat, comprising the steps of:
a) recycling step: collecting recycled insoles or collecting recycled insoles and at least one of waste generated during the production of TPU and/or EVA copolymer and offcuts generated during the production of insole pads, to obtain recycled materials, wherein the recycled insoles comprise pads and fabrics attached to the pads, the pads are made of TPU and/or EVA copolymer, and the fabrics are made from at least one selected from the group consisting of plant fibers, animal fibers, and synthetic fibers;
b) shredding step: shredding the recycled materials to obtain recycled polymer scraps having an average particle size between 0.3 mm to 5 mm and recycled fiber scraps having an average fiber length between 0.3 mm to 5 mm;
c) heating and mixing step: heating and homogeneously mixing the recycled polymer scraps, the recycled fiber scraps, and a polyether-based adhesive to obtain a composition, wherein
based on 100 parts by weight of the polyether-based adhesive, the composition comprises 260 to 340 parts by weight of the recycled polymer scraps and 10 to 100 parts by weight of the recycled fiber scraps; and
d) cooling and molding step: introducing the composition into a mold, cooling to solidify the composition, and demolding to produce an eco-friendly mat.

6. The manufacturing method of eco-friendly mat as claimed in claim 5, wherein the shredding step is performed by shredding the recycled materials with a shredder.

7. The manufacturing method of eco-friendly mat as claimed in claim 5, wherein the heating and mixing step is performed by steam heating the composition at a temperature ranging from 100° C. to 140° C.

8. The manufacturing method of eco-friendly mat as claimed in claim 5, wherein the cooling and molding step is performed by placing the mold containing the composition in an oven at a temperature of 50° C. to 60° C. for 5 to 8 hours to cool and solidify the composition.

9. An eco-friendly mat made from the composition as claimed in claim 1.

10. The eco-friendly mat as claimed in claim 9, wherein the eco-friendly mat has a tear strength of 0.6 kg/cm or higher as measured by ASTM D624, an impact resilience of 24% to 28% as measured by ASTM D2632, a specific gravity of 0.19 to 0.27 g/cm³ as measured by NIKE Test G43, and an ASKER C hardness of 26 to 48 as measured by NIKE Test G45.
